(19) United States
(12) Patent Application Publication
(10) Pub. No.: US 2015/0323939 A1
(43) Pub. Date: Nov. 12, 2015

(54) HOME INTELLECTUAL AIR CONDITIONING SYSTEM

(71) Applicant: Wen-Sung Lee, Taichung City (TW)

(72) Inventor: Wen-Sung Lee, Taichung City (TW)

(21) Appl. No.: 14/275,862

(22) Filed: May 12, 2014

(51) Int. Cl. G05D 23/00

(52) U.S. Cl. CPC G05D 23/00

(57) ABSTRACT

A home intellectual air conditioning system for use in a house with at least one room, the system includes at least one air conditioner disposed in the room and an intellectual controller for interaction with the air conditioner. The intellectual controller has an identification sensor, a positioning system, a time unit and a processor. The identification sensor is configured to identify presence of a home member and transmit ID information of the home member to the processor. The positioning system is configured to track position of the home member within the house and transmit position information of the home member to the processor. The time unit is configured to transmit time information to the processor. The processor is configured to direct the air conditioner to operate according to the ID information, the position information of the home member and the time information.

### BACKGROUND OF THE INVENTION

1. Field of the Invention

The present invention relates to an air conditioning system, and more particularly to a home intellectual air conditioning system that provides an optimum air condition control service for the home members.

2. Description of Related Art

Air conditioning is the process of altering the properties of air to more favorable conditions, typically with the aim of distributing the conditioned air to an occupied space to improve comfort. Specifically, air conditioning can refer to any form of technology, heating, cooling, de-humidification, humidification, cleaning, ventilation, or air movement, which modifies the condition of air. Generally, an air conditioner is a major or home appliance, system, or mechanism designed to change the air temperature and humidity within an area.

The conventional air conditioner generally contains a temperature control apparatus for controlling indoor temperature in a constant temperature. However, the conventional air conditioner cannot be automatically operated to control the indoor temperature by the presence of any home member, which is not smart enough to accommodate the special needs of each home member.

The present invention has arisen to mitigate and/or obviate the disadvantages of the conventional air conditioner.

### SUMMARY OF THE INVENTION

The main objective of the present invention is to provide an improved intellectual air conditioning system.

To achieve the objective, a home intellectual air conditioning system for use in a house with at least one room, the system comprises at least one air conditioner disposed in the room and an intellectual controller for interaction with the air conditioner. The intellectual controller has an identification sensor, a positioning system, a time unit and a processor. The identification sensor is configured to identify presence of a home member and transmit ID information of the home member to the processor. The positioning system is configured to track position of the home member within the house and transmit position information of the home member to the processor. The time unit is configured to transmit time information to the processor. The processor is configured to direct the air conditioner to operate according to the ID information, the position information of the home member and the time information.

Preferably, a database storing a plurality of temporal parameters and preset temperature values corresponding to the temporal parameters. The processor correlates the time information of the time unit with the temporal parameters to adjust temperature of the room to the respective preset temperature value for operation of the air conditioner.

Preferably, at least one outdoor temperature sensor for detecting outdoor temperature to generate an outdoor temperature value, and at least one indoor temperature sensor for detecting indoor temperature to generate an indoor temperature value. The database further stores a preset temperature difference, and the processor correlates a temperature difference between the outdoor temperature value and the indoor temperature value with the preset temperature difference to generate a target temperature value for operation of the air conditioner.

Preferably, at least one humidity sensor disposed in the room for detecting humidity of the room to generate a humidity value; wherein the database further stores a normal humidity parameter, and once the humidity value is higher than the normal humidity parameter, the processor directs the air conditioner to operate with dehumidifying function.

Specifically, the processor is configured to receive the ID information and the position information to determine a number of home members. The database further stores number parameters and control parameters corresponding to the number parameters. The processor correlates the number of home members with the number parameters to operate the air conditioner with the respective control parameter.

Preferably, the ID information includes individual identity and individual body temperature. The database further stores body temperature ranges and control parameters corresponding to the body temperature ranges; and the processor correlates an average body temperature with the body temperature ranges to operate the air conditioner with the respective control parameter.

Preferably, the database stores identification codes and customary temperature values corresponding to the identification codes; and the processor correlates the ID information of the home member with the identification codes to adjust the air conditioner to the respective customary temperature value.

Preferably, the time unit further has a time clock interacting with the processor. Once the identification sensor and the positioning system identify no home member in the room, the processor transmits a vacant signal to the time unit, and the time clock generates a predetermined time to the processor; and the processor directs the air conditioner to switch off at the predetermined time.

Preferably, at least one window closing device disposed in a window of the room. Once the air conditioner is operated, the processor transmits a close signal to the window closing device to automatically close the window. Furthermore, when the air conditioner is operated, the processor could direct at least one fan to operate.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of the home intellectual air conditioning system of the present invention;

FIG. 2 is another block diagram of the home intellectual air conditioning system of the present invention;

FIG. 3 illustrates that an intellectual controller interaction with the air conditioners in the house;

FIG. 4 illustrates that the home intellectual air conditioning system is disposed in the house while the home members are located in different rooms; and

FIG. 5 illustrates that the window is automatically closed while the air conditioner is operated.

### DETAILED DESCRIPTION OF THE INVENTION

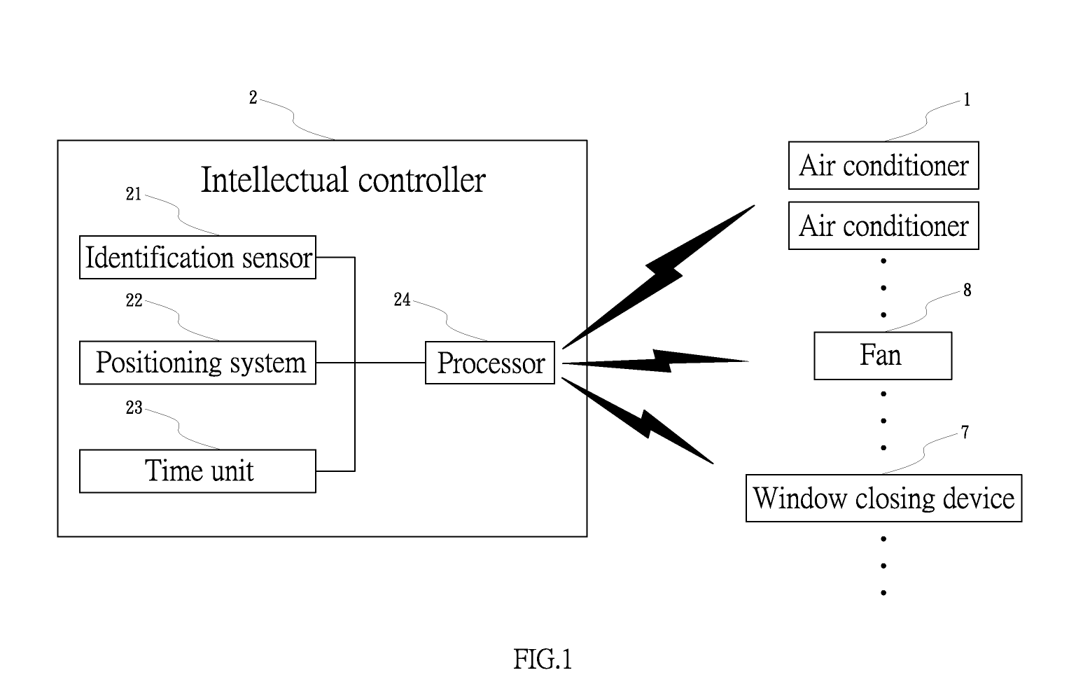

Referring to FIGS. 1-3, a home intellectual air conditioning system in accordance with a preferred embodiment of the present invention is disposed in a house, wherein the house has a plurality of rooms 10. The home intellectual air conditioning system comprises at least one air conditioner 1 disposed in the respective room 10 and an intellectual controller 2 for interaction with the air conditioner 1.

The intellectual controller 2 has an identification sensor 21, a positioning system 22, a time unit 23 and a processor 24. The identification sensor 21 is configured to identify presence of any home member in the house and transmit ID information of the home member to the processor 24. The positioning system 22 is configured to track position of the home member within the house and transmit position information of the home member to the processor 24. The time unit 23 is configured to transmit time information to the processor 24. The processor 24 is configured to direct the air conditioner 1 to operate according to the ID information, the position information of the home member and the time information.

Under this arrangement, the air conditioner 1 could be automatically controlled by the intellectual controller 2 according to the ID information, the position information of the home member and the time information. In other words, the home intellectual air conditioning system can identify each home member and provide customized service for each home member.

Specifically, the home intellectual air conditioning system further comprises a database 3 storing a plurality of temporal parameters and preset temperature values corresponding to the temporal parameters. The temporal parameters include parameters based on seasons and any part of the day. The processor 24 correlates the time information of the time unit 23 with the temporal parameters to adjust the temperature of the respective room 10 to the preset temperature value for operation of the air conditioner 1.

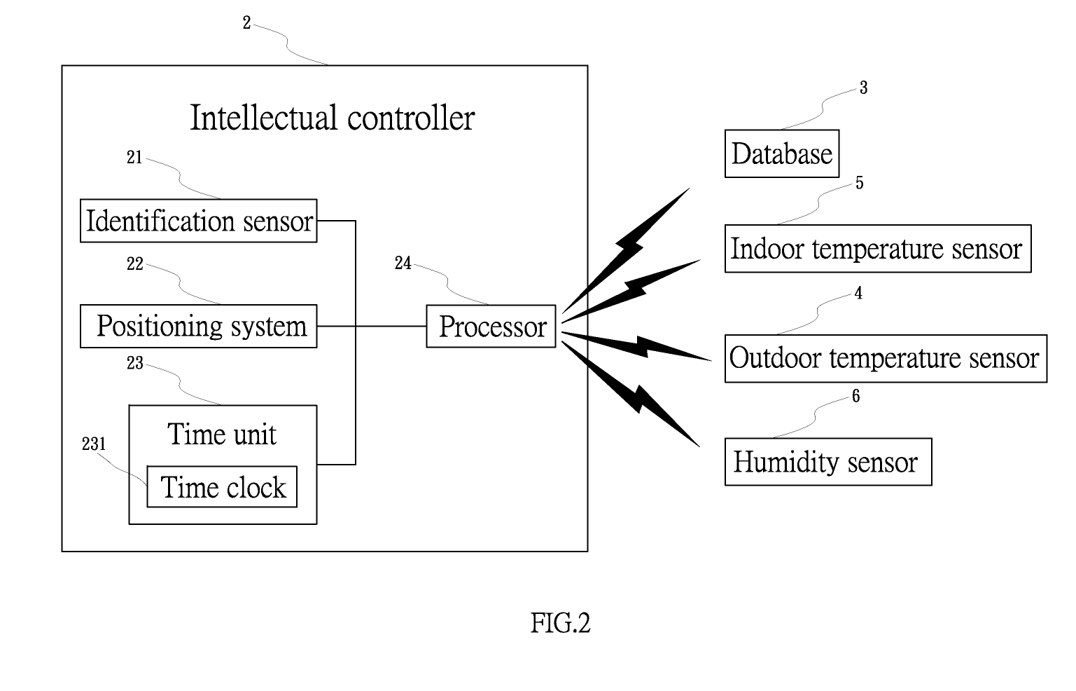

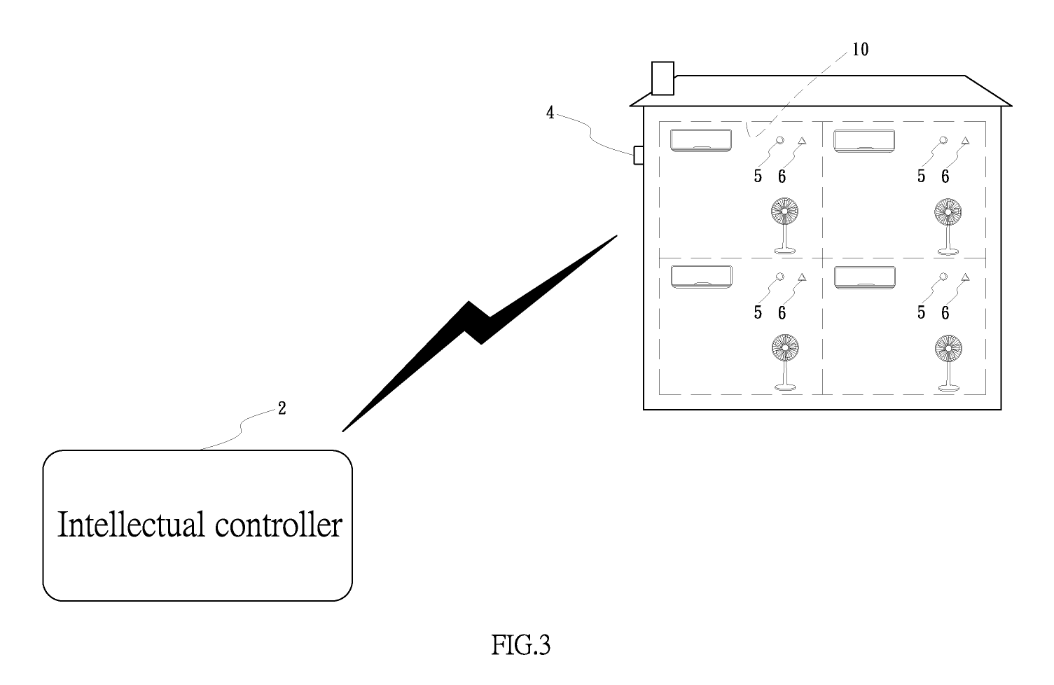

Referring to FIGS. 2-3, the home intellectual air conditioning system further comprises at least one outdoor temperature sensor 4 for detecting outdoor temperature to generate an outdoor temperature value, and at least one indoor temperature sensor 5 for detecting indoor temperature to generate an indoor temperature value. The database 3 further stores a preset temperature difference, and the processor 24 correlates a temperature difference between the outdoor temperature value and the indoor temperature value with the preset temperature difference to generate a target temperature value for operation of the air conditioner 1.

Moreover, the home intellectual air conditioning system further comprises at least one humidity sensor 6 disposed in the respective room 10 for detecting humidity of the respective room 10 and to generate a humidity value. The database 3 further stores a normal humidity parameter. Once the humidity value is higher than the normal humidity parameter, the processor 24 directs the air conditioner 1 to operate with dehumidifying function.

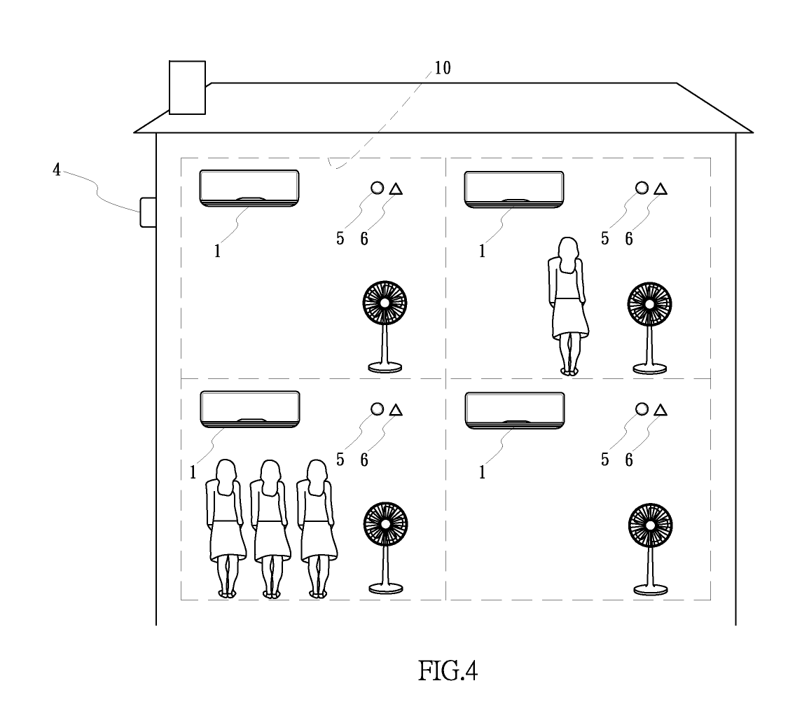

As shown in FIG. 4, the indoor temperature will be changed according to the number of home members. The processor 24 is configured to receive the ID information and the position information to determine the number of home members. The database 3 further stores number parameters and control parameters corresponding to the number parameters. The processor 24 correlates the number of home members with the number parameters to operate the air conditioner 1 with the respective control parameter.

Preferably, the ID information includes individual identity and individual body temperature. The database 3 further stores body temperature ranges and control parameters corresponding to the body temperature ranges. The processor 24 correlates an average body temperature with the body temperature ranges to operate the air conditioner 1 with the respective control parameter. In addition, the database 3 stores identification codes and customary temperature values corresponding to the identification codes. The processor 24 correlates the ID information of the home member with the identification codes to adjust the air conditioner 1 to the respective customary temperature value.

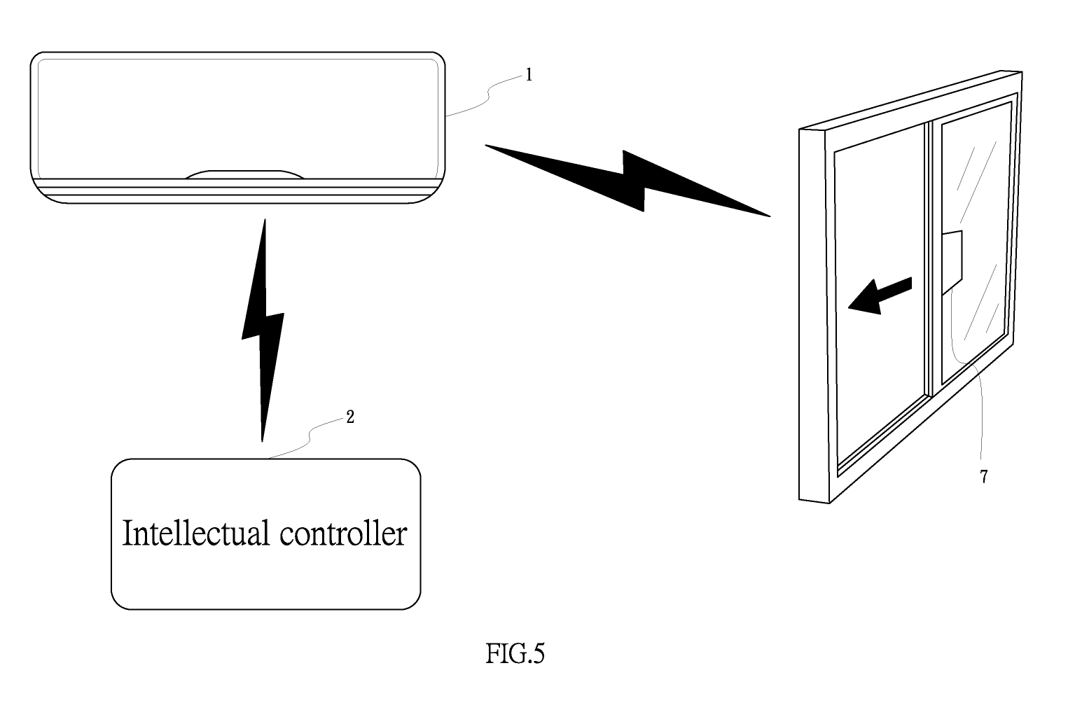

Referring to FIG. 2, the time unit 23 further has a time clock 231 interacting with the processor 24. Once the identification sensor 21 and the positioning system 22 identify no home member in any room 10, the processor 24 transmits a vacant signal to the time unit 23, and the time clock 231 generates a predetermined time to the processor 24. While at the predetermined time, the processor 24 directs the air conditioner 1 to switch off Furthermore, as shown in FIG. 5, at least one window closing device 7 is disposed in a window of the respective room 10. Once the air conditioner 1 is operated, the processor 24 transmits a close signal to the window closing device 7 to automatically close the window. Specifically, the home intellectual air conditioning system further includes at least one fan 8. When the air conditioner 1 is operated, the processor 24 also directs the fan 8 to operate.

Although embodiments of this invention have been fully described with reference to the accompanying drawings, it is to be understood that various modifications can be made by those skilled in the art without departing from the scope of the invention as hereinafter claimed.

What is claimed is:

1. A home intellectual air conditioning system for use in a house with at least one room, the system comprising:
at least one air conditioner disposed in the room; and
an intellectual controller for interaction with the air conditioner, having an identification sensor, a positioning system, a time unit and a processor, the identification sensor configured to identify presence of a home member and transmit ID information of the home member to the processor, the positioning system configured to track position of the home member within the house and transmit position information of the home member to the processor, the time unit configured to transmit time information to the processor, the processor configured to direct the air conditioner to operate according to the ID information, the position information of the home member and the time information.

2. The home intellectual air conditioning system as claimed in claim 1, further comprising a database storing a plurality of temporal parameters and preset temperature values corresponding to the temporal parameters; wherein the processor correlates the time information of the time unit with the temporal parameters to adjust temperature of the room to the respective preset temperature value for operation of the air conditioner.

3. The home intellectual air conditioning system as claimed in claim 2, further comprising at least one outdoor temperature sensor for detecting outdoor temperature to generate an outdoor temperature value, and at least one indoor temperature sensor for detecting indoor temperature to generate an indoor temperature value; wherein the database further stores a preset temperature difference, and the processor correlates a temperature difference between the outdoor temperature value and the indoor temperature value with the preset temperature difference to generate a target temperature value for operation of the air conditioner.

4. The home intellectual air conditioning system as claimed in claim 2, further comprising at least one humidity sensor disposed in the room for detecting humidity of the room to generate a humidity value; wherein the database further stores a normal humidity parameter, and once the humidity value is higher than the normal humidity parameter, the processor directs the air conditioner to operate with dehumidifying function.

5. The home intellectual air conditioning system as claimed in claim 2, wherein the processor is configured to receive the ID information and the position information to determine a number of home members; the database further stores number parameters and control parameters corresponding to the number parameters; and the processor correlates the number of home members with the number parameters to operate the air conditioner with the respective control parameter.

6. The home intellectual air conditioning system as claimed in claim 2, wherein the ID information includes individual identity and individual body temperature; the database further stores body temperature ranges and control parameters corresponding to the body temperature ranges; and the processor correlates an average body temperature with the body temperature ranges to operate the air conditioner with the respective control parameter.

7. The home intellectual air conditioning system as claimed in claim 2, wherein the database stores identification codes and customary temperature values corresponding to the identification codes; and the processor correlates the ID information of the home member with the identification codes to adjust the air conditioner to the respective customary temperature value.

8. The home intellectual air conditioning system as claimed in claim 1, wherein the time unit further has a time clock interacting with the processor; once the identification sensor and the positioning system identify no home member in the room, the processor transmits a vacant signal to the time unit, and the time clock generates a predetermined time to the processor; and the processor directs the air conditioner to switch off at the predetermined time.

9. The home intellectual air conditioning system as claimed in claim 1, further comprising at least one window closing device disposed in a window of the room; wherein once the air conditioner is operated, the processor transmits a close signal to the window closing device to automatically close the window.

10. The home intellectual air conditioning system as claimed in claim 1, further comprising at least one fan; when the air conditioner is operated, the processor also directs the fan to operate.
